(19) United States
(12) Patent Application Publication
(10) Pub. No.: US 2007/0198583 A1
(43) Pub. Date: Aug. 23, 2007

(54) Safety test support system,method,and program

(75) Inventor: Takaharu Hamada, Osaka (JP)

Correspondence Address: WOODCOCK WASHBURN LLP, CIRA CENTRE, 12TH FLOOR, 2929 ARCH STREET, PHILADELPHIA, PA, 19104-2891, US

(73) Assignee: H & T CORPORATION, OSAKA (JP)

(21) Appl. No.: 10/584,167

(22) PCT Filed: Dec. 27, 2004
(86) PCT No.: PCT/JP04/19565

§ 371 Date: Jun. 22, 2006

(30) Foreign Application Priority Data
Dec. 25, 2003 (JP) 2004-429897

(51) Int. Cl. G06F 17/30; G06F 17/00

(52) U.S. Cl. 707/104.1

(57) ABSTRACT

The present invention aims to provide a safety test support system capable of guaranteeing strict GLP, and the like, through performing inspections that automatically detect changes during the operation of a system.

A main aspect of the present invention comprises the provision of a storage unit 5 for storing applications related to multiple types of safety tests, functionally divided by data items and/or operations; application running means 7 for running at least one application selected from among the aforementioned multiple types of applications; a inspection scenario storage unit 17 for storing multiple types of inspection scenarios for detecting changes in the operation of the system in the respective applications, corresponding respectively to the aforementioned multiple types of applications; and inspection executing means 19 for detecting changes in each application through sequentially executing the inspection scenarios of the aforementioned inspection scenario storage unit 17.

### CROSS REFERENCE TO RELATED APPLICATIONS

This application claims priority under 35 U.S.C. 119 based upon Japanese Patent Application Serial No. 2003-429897, filed on Dec. 25, 2003. The entire disclosure of the aforesaid application is incorporated herein by reference.

### FIELD OF THE INVENTION

The present invention relates to safety test support systems, methods, and programs that can be applied to chemical products test data control, and the like, that records, controls, and tabulates the weight, food intake, water intake, biochemical inspection, observations of clinical conditions, pathological findings, urinary output, opthalmological examinations, hematological examinations, and the like, when organisms are given administrations, and, in particular, to safety test support systems, methods, and programs that are suitable to toxicity testing of chemical products when animals are used as the organisms.

### BACKGROUND OF THE INVENTION

The carcinogenicity, toxicity, and other aspects of safety to the human body of pharmaceuticals, agricultural chemicals, food additives, and the like is the subject of clinical testing prior to market release, but prior to entering into clinical testing, checks are performed through non-clinical testing using animals such as rats and mice.

In safety studies of chemical products, and the like, using animals, there are: single-administration toxicity tests for determining the toxicity characteristics of the quantity that is administered in a single administration that will give rise to toxicity; repeated dose toxicity studies; reproduction toxicity studies that indicate the effect on the reproduction on parental animals and the impact on the next generation; mutagenicity studies that indicate whether or not there is material that exhibits damage to DNA or the property of inducing mutations, carcinogenicity studies; skin sensitivity studies; skin photosensitizing effect studies, and dependency studies.

Each of these studies described above is performed through the chemical product being actually administered to the animal, and the weight, food intake, water intake, urine production, etc., being measured, clinical conditions being observed and pathological histologies being performed, and the data that is taken being tabulated and analyzed.

This type of safety testing is performed prior to clinical studies wherein the chemical product is actually administered to humans. Moreover, in investigating the ultimate impact on the human body, it is necessary to accurately understand and analyze the impact of the chemical product on the organism. To do this, computer systems have conventionally been used in recording, controlling, and analyzing the data (for example, the safety evaluation program as disclosed in Japanese Unexamined Patent Application Publication No. H07-110325). Moreover, because pharmaceutical products and other chemical products have an effect on the human body, strict standards have been put in place by various governmental agencies, such as the Japanese Ministry of Health and Welfare, in the controlling of safety data, such as described above, so that there will be no falsification of data. These standards are known by the general term, “Good Laboratory Practice” (GLP), and, of course, the computer systems that control the data must comply with the GLP standards.

In other words, first, when a system is implemented, it is necessary to perform a validation at the time of implementation to verify whether or not the operations conform strictly with GLP. Moreover, even after the system has commenced operations, if there is, for example, a modification that must be considered to be part of the system, it is necessary to maintain documentation of repeated validation testing for the system as a whole that the system is operating in strict compliance with GLP, and necessary to guarantee that there is no falsification of data or tampering with the system.

The implementation and operation of this type of system is extremely costly due to the extremely specialized knowledge that is required in the extreme niche market.

In conventional safety test systems, even if the system comprises multiple different functions, the system would be implemented and operated as one single system, so as to guarantee GLP in the system as a whole. Because of this, even if there were a version upgrade in only one of the application programs in the system, it would be necessary to perform validation all over again for the entire system.

For example, in recent years there have frequently been security patches provided by operating system (OS) suppliers due to the spread of programs that can destroy a system, such as virus programs that exploit security holes in a system. In order to operate a system safely, it is imperative that updating be performed immediately when security patches are provided.

However, in conventional systems that guarantee GLP, etc., in the system as a whole, it is necessary to perform validations even when all that has been done is the application of a security patch to the operating system, because there has been a change to the system as a whole. Normally this type of validation during operations requires three months or more for a staff of two or three individuals to perform. Therefore, even though Installation Testing is performed when systems are received, once the system are implemented and operations are commenced, the reality is that validations and the like, are essentially never performed after functional upgrades, or the like. Consequently, in actual operations, operation is continued without any updates or functional upgrades, in order to be able to continue operating without performing validations.

Given this situation, even when a security hole is discovered after the commencement of operations, it is not possible to apply a security patch, and the system continues to be used even in a state wherein there is a threat to the security of the system. Moreover, while the software itself can be used on general-use hardware, because it is necessary to perform validations even on other unrelated software, or on the operating system that functions as a general-use machine, essentially operations require the preparation of dedicated equipment, and the cost of system implementation is extremely high.

Additionally, a variety of different systems for performing validations of systems have been disclosed (such as in the program test support device disclosed in Japanese Unexamined Patent Application Publication No. H10-275093). However, conventional validation systems have been used primarily for discovering and correcting bugs in programs that are under development, and thus when even slight differences have been detected in the results of validations, these variations have been detected and a “Fail” result has been outputted. However, when this type of validation system is applied to a safety testing support system for software that is actually in use, a “bug” or “change” has been detected even when the variation has been on a level that has absolutely no impact whatsoever on the operation of the safety testing support system for guaranteeing GLP, etc., such as a minor change in the font or in the color of a display, resulting in the output of a “Fail,” where each time a “Fail” is outputted there is the need for a recheck by a human. Consequently, even if there have been automatic inspections, in practice the inspections and validations have required substantial manpower.

Moreover, in systems wherein all functions have been integrated, such as has been done in the past, there have been large numbers of functions included that have not been used, and even though users have been authenticated at the time of system startup by the addition of this type of extra function, operations have continued thereafter [without re-authenticating the users] until the next time that the system is shut down, even if the user is replaced with a different user during the process, and thus essentially it has not been possible to authenticate the user in practice, which has been a problem in guaranteeing GLP, etc.

The present invention is the result of contemplation of this situation, and the object thereof is to provide a computer software capable of detecting automatically changes that affect the system operation, and capable of guaranteeing strict compliance with standards such as GLP.

### SUMMARY OF THE INVENTION

A first aspect of the present invention provides a computer software program for detecting whether or not there have been one or more specific changes in one or more application programs running on a computer system, comprising: a storage medium; an authentication program for authenticating a user prior to the execution of at least one of said application programs, and for associating the user in the aforementioned authentication to an application program that will be run later; inspection scenarios, associated with each of said application programs and stored on said storage medium, for detecting whether or not there have been specific changes in each of said application programs; and an inspection scenario program, stored on said storage medium, for detecting whether or not there has been a specific change in an application program, by running said associated specific application program according to said inspection scenario, and for outputting detection results in association with said user name and said application program. Here the computer program is, for example, to guarantee (perform validation) that the results of safety testing have not been tampered with or fabricated in the aforementioned application program, where the aforementioned application program receives measurement values, that are not fabricated nor tampered with, from measurement devices for safety testing, and processes the measurement values to output specific processing results.

That is, the present invention is, most preferably, applied to a safety testing system structured from, for example, a plurality of related application programs that are functionally divided by data item and/or operation. This invention makes it possible, when there has been some type of change in a portion of an application program, to detect for each application program whether or not the change is within a permissible scope based on a validation that has already been performed, and to output and record the results in association with the user that indicated the results. This makes it possible to guarantee with certainty the effectiveness of the validation.

In the first form of an embodiment according to the present invention, said one or more application programs includes an application program launcher for displaying the other application programs to the user selectively and executably.

This configuration makes it possible for the user to easily discern, and control, a plurality of mutually-related application software programs that are the subject of the present invention.

In another form of an embodiment according to the present invention, said one or more application programs is a plurality of application programs requiring validations in order to fulfill specific standards under identical policies; said inspection scenarios are for detecting whether or not changes in each application program are to the degree that allows execution of the application program without performing a re-validation; and said inspection scenario program instructs said computer system to display the detection result, when, in accordance with said inspection scenario, a change of an extent greater than that wherein execution is allowed without performing validations is detected. Here the aforementioned policy includes policies related to controlling safety data, such as “GLP” (Good Laboratory Practice).

Moreover, in yet another form of an embodiment, said inspection scenario program inputs a dummy signal into said application program in accordance with said inspection scenario to detect a response signal to said inputted dummy signal, to thereby detect whether or not there has been a specific change in the application program. This inspection scenario preferably includes at least data that specifies an application program to be inspected, data that is inputted into the application program as dummy signals, and data regarding the acceptable range for responses to these data.

This type of configuration makes it possible to prepare high accuracy scenarios for each application, and to perform processes based on the scenarios in the applications to detect specific changes based on the response signals. Note that these “dummy signals” are signals that are produced by another program (such as an operating system event program, or the like) or by an inspection scenario program based on the inspection scenario, and are not inputted by the user using a keyboard or the like.

In yet another form of an embodiment, the aforementioned inspection scenario program is run at specific time intervals.

In yet another form of an embodiment, said inspection scenario program comprises a detection results display unit for displaying said detection results on a computer display, and a user input/output unit for receiving user input regarding said detection results and for outputting in association with said detection results.

In yet another form of an embodiment, said authenticating program comprises an authentication update requesting unit for requesting the input of user authentication data at each specific time interval; and if the user cannot be authenticated by said authentication update requesting unit, terminates said application program that is running, associated with the applicable user.

In yet another form of an embodiment, said authentication program performs repeat user authentication in response to a user request after an initial user authentication, and associates, with the user involved in said authentication, the application programs currently running, and application programs run thereafter.

A second main aspect of the present invention provides an application program inspecting system comprising: an application storage unit for storing one or more mutually-related application programs; an authentication unit for performing user authentication prior to running at least the first of said application programs, and for associating application programs run thereafter, with the user involved in said authentication; an inspection scenario storage unit for storing inspection scenarios, associated with each of said application programs, for detecting whether or not there have been specific changes in each of said application programs; and an inspecting unit for detecting whether or not there have been specific changes in said application programs, through an inspection scenario program executing specific related application programs in accordance with said inspection scenarios, and for outputting said detection results in association with said user name and application program.

A third main aspect of the present invention provides a method for detecting whether or not there have been one or more specific changes in one or more mutually-related application programs on a computer system, comprising: an authentication process for performing user authentication prior to running at least the first of said application programs and for associating, with said application programs run thereafter, the user involved in said authentication; and an inspection process for detecting whether or not there has been a specific change in said application program, through the use of an inspection scenario, associated with each application program, for detecting whether or not there has been a specific change in each of the application programs, by an inspection scenario program executing a specific related application program in accordance with said inspection scenario, and outputting the detection results in association with said user name and application program.

The present invention makes it possible for the aforementioned inspection scenario program to greatly reduce the amount of reconfirmation work of “Fail” outputs through checks by humans by not defining as “changes” those changes occurring during the operation of an inspected system that are recognized as changes that do not affect the system operation, and by not defining as a “change” those changes that have absolutely no impact on the operation of the safety test support system for guaranteeing, for example, GLP, such as minor changes in fonts or minor changes in display colors, when a change has been detected as being a change that does impact the system operation, without outputting a “Fail,” as being a “change,” which, conventionally, would have been produced for all changes in the system.

Moreover, the present invention is able to detect pure system changes, excluding those caused by devices or drivers, by inputting dummy signals directly into the application program when performing comparisons of detected response signals with those prior to the start of the validation testing by detecting the response signals to inputted dummy signals, by inputting dummy signals directly to specified application programs by the inspection scenario program specifying application programs as being the subject of the validation testing in the validation testing of the various application programs by the aforementioned validation testing execution means. As a result, the ease of use of the system is insured through changes in devices and drivers not having an impact on the operations and inspections.

The present invention is able to detect pure system changes, excluding those caused by the operating system, rather than just those caused by devices and drivers, through inputting dummy signals directly into application programs without passing through the operating system, when the aforementioned inputting of dummy signals is performed without passing through the operating system.

In the present invention, changes in the system, including the operating system, can be detected through inputting dummy signals directly into application programs through the operating system when the aforementioned dummy signals are inputted through the operating system.

When the present invention is provided with display means for displaying a list of application programs stored in the aforementioned program storage unit, program selecting means for selecting the desired application program to run from a list of application programs displayed by the aforementioned display means, running means for running the application program selected by the aforementioned program selecting means, run confirming means for confirming, at specific time intervals, that any of the aforementioned run applications programs have been run, and user authentication means for requesting the input of user authentication data, at specific intervals, following the confirming of the running of any of the application programs by the aforementioned run confirming means, it is possible to perform user authentication when the system is started up, and then, thereafter, to essentially authenticate the user by performing user authentication at specific intervals after any of the run application programs have been run, making it possible to guarantee with certainty the GLP, etc.

Providing the present invention with authentication data maintaining means for maintaining valid data for user authentication by user authenticating means eliminates redundant work and supports ease of use by not performing user authentication each time an application is run, insofar as the user authentication is valid, by running application programs when the authentication is valid, and not running application programs when the authentication is invalid, based on the validity data that is maintained in the aforementioned authentication data maintaining means when an application program is run.

The present invention improves operating efficiency by eliminating the need for performing user authentication each time another application program is run while any of the application programs is running because it is possible to control the authentication of multiple application programs using a single user authenticating means by a registered application program checking the operation of the user authenticating means when the aforementioned application program is run, and running the user authenticating means if the user authenticating means is not already started. Moreover, because the registered application program does not run the user authenticating means when another application program is already running, it is possible to avoid problems with consuming more memory capacity than required, which leads to, for example, a drop in operating speed.

The present invention is able to greatly reduce the overall system cost by being able to implement only the required application programs that have a high probability of use, given that when the present invention is used in pharmaceutical toxicity studies using animals as the organisms, the pharmaceutical toxicity studies using animals as organisms have vast amount of data of many different types, and given that the types of data required will vary depending on the user. Moreover, because it is possible for multiple observers to enter data, etc., at different times, the effects of the present invention being able to confirm the user, etc., at regular intervals, are remarkably effective.

### BRIEF DESCRIPTION OF THE DRAWINGS

FIG. 1 shows a system structure drawing illustrating one form of an embodiment of a safety test support system according to the present invention;

FIG. 2 shows a diagram illustrating one example of a display screen of the application running means;

FIG. 3 shows a diagram for explaining the operation of the aforementioned safety test support system;

FIG. 4 shows a flowchart for explaining the operation of the aforementioned safety test support system; and

FIG. 5 shows a flowchart for explaining the operation of the aforementioned safety test support system.

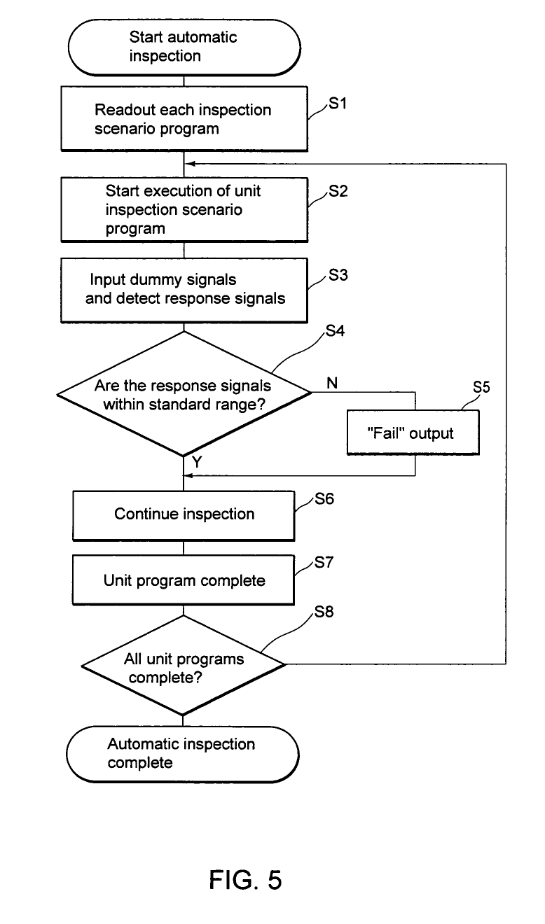

### DETAILED DESCRIPTION OF THE INVENTION

The most preferred form according to the present invention will be described in the following.

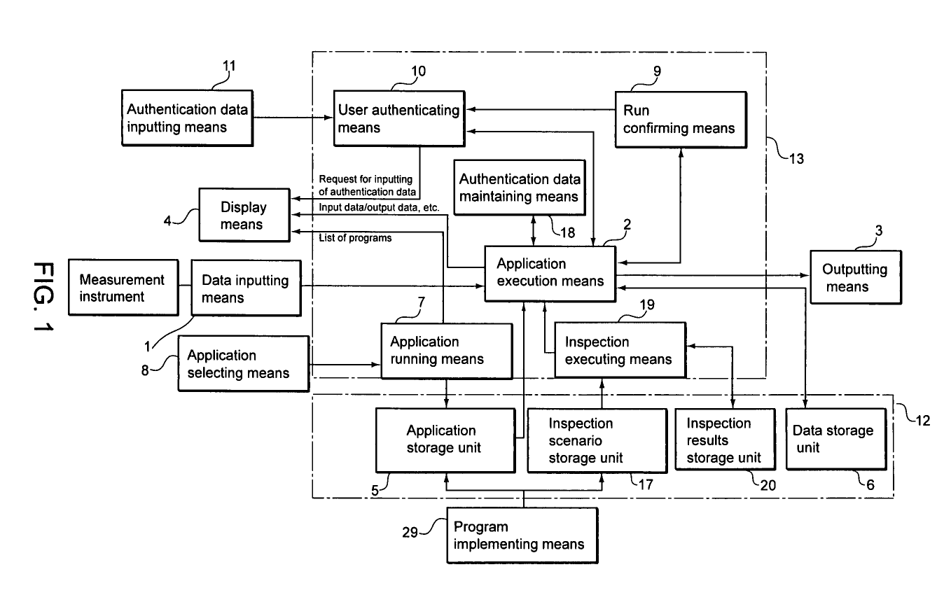

FIG. 1 is a system structure diagram illustrating a first form of an embodiment of a safety test support system according to the present invention. This system illustrates an example of an application of the present invention to a pharmaceutical trial data control system, provided with data inputting means 1 for inputting data such as the actual weight of the animal when the pharmaceutical substance was administered, amounts of food, water, urine, etc., via chemical examinations, hematological examinations, clinical observations, pathological findings, and the like, and application executing means 2 for receiving the data inputted by the data inputting means 1 and executing the various application programs described below (hereinafter termed “application”) to tabulate, etc., the data.

Here the data inputting means 1 may be a keyboard or a mouse, or, for example, an electronic scale, an electron microscope, a density meter, or another measurement instrument, where the measured values by these instruments are preferably connected directly to the aforementioned application.

Moreover, the aforementioned system is provided with outputting means 3 such as a printer for printing out reports of the data that is tabulated, etc., by the aforementioned application executing means 2, and display means 4, such as a display, for displaying various types of data during data input and data output, etc. Moreover, the aforementioned system is also provided with a data storage unit 6 for storing inputted data through the application executing means 2. In the figure, 12 is a memory device such as a hard disk, an MO [(a mini optical disk)], or the like, and 13 is an operating unit provided with, for example, a CPU, memory, and so forth.

Here, the aforementioned system is structured from the aforementioned means so as to be able to perform the ordinary processes of, for example, data input, tabulation, and the like. In other words, the data that is inputted by the data inputting means 1 is stored in the data storage unit 6 by the application executing means 2, and, during the data input operations, the data that is entered, along with other necessary information, is displayed on the display means 4. Moreover, when tabulating, processing, etc., the data that has been inputted, the tabulated or processed data is outputted from the outputting means 3 and, along with the outputted data, other necessary information is displayed on the display means 4.

Moreover, the system described above is provided with an application storage unit 5 that functions as a first program storage unit according to the present invention for storing applications for multiple operations. The aforementioned application storage unit 5 stores multiple applications that are functionally separated by the type of data and/or operation, such as inputting body weight, tabulating body weight, outputting tabulated data regarding body weight, inputting pathological finding, tabulating pathological findings, outputting pathological findings, and so forth. The applications stored in the aforementioned application storage unit 5 are sent, in the form of being stored on a storage medium such as a CD-ROM, through a program implementing means 29, such as a CD-ROM drive, to be installed on the hard disk of a computer, so that the applications can be installed at any time.

Moreover, the system described above is provided with application running means 7 (a launcher program) for registering each application that is stored in the aforementioned application storage unit 5 and for running applications selected by the user from among the aforementioned registered applications. Moreover, the application storage unit 5 stores each application storage area associated with the registration location of the program, in association with the program registration location for the application running means 7. This association is stored in the aforementioned application running means 7 (launcher program).

Moreover, the structure is such that a list of the applications registered in the aforementioned application running means 7 is displayed on the display means 4, and an application selecting means 8 is provided for the user to select, from the application list displayed on the aforementioned display means 4, the application to be run. Note that the aforementioned application running means 7 may be included as one of the aforementioned applications, and may be stored, as a program, in the aforementioned application storage unit 5.

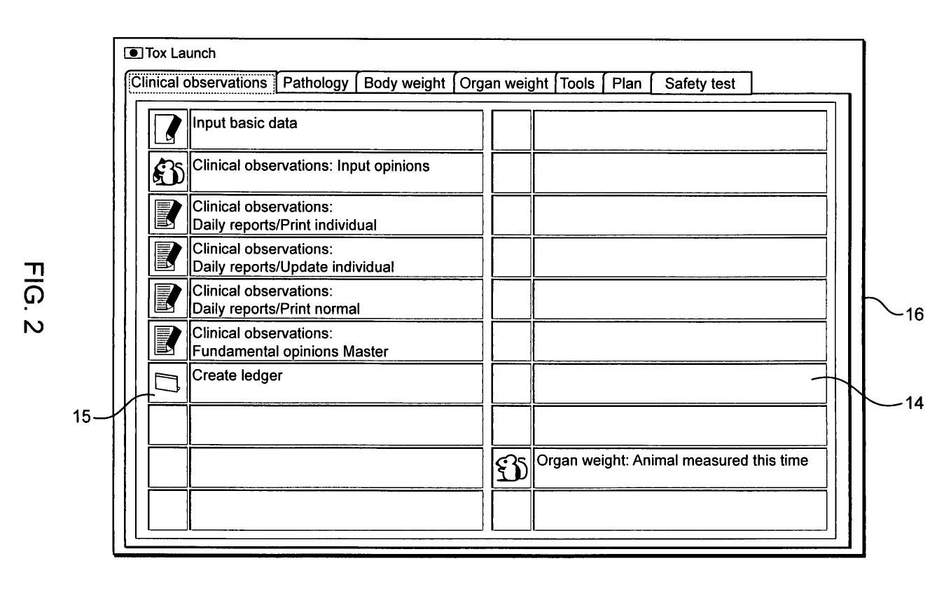

In selecting an application using the aforementioned application selecting means 8, an input device, such as a mouse, or the like, is used to select the desired program to be run from a list of applications shown on a menu 14 that is displayed on a screen 16 of the display means 4, as shown in FIG. 2, and is run via aligning the mouse pointer (not shown) on an icon 15 and performing a double click. Note that either a single application may be run, or two or more applications may be run at the same time.

Moreover, the application selected by the application selecting means 8 is run by the application running means 7 based on the aforementioned associated data. The running of the application is performed through reading and decoding the application from the application storage unit 5 into memory, and then receiving execution authorization from the operating system. The application that has been run is executed by the application executing means 2.

Furthermore, the system described above is provided with run confirming means 9 for confirming at prescribed intervals (such as 5 minutes) whether or not the application that has been run by the application running means 7 and that is being executed on the application executing means 2, is still running. This run confirming operation is performed through querying the operating system as to whether or not the application is deployed in memory and being executed.

Moreover, user authenticating means 10 are provided for requesting the input of user authentication data at prescribed intervals (for example, 30 minutes) while any of the applications is confirmed by the aforementioned run confirming means 9. Furthermore, authentication data inputting means 11 for inputting authentication data in accordance with the authentication data input request from the aforementioned user authenticating means 10 are provided. Here the time interval for requesting the inputting of the authentication data (authentication time) is set so as to be longer than the time for confirming the running of the application (the run confirming time).

The aforementioned data input request is performed through displaying a password input screen, with a prompt for inputting a password, on the display means 4, for example. Moreover, a device such as a keyboard may be used in inputting authentication data, which may be performed through using the aforementioned authentication data inputting means 11 to input a password into the aforementioned password input screen.

Moreover, the aforementioned run confirming means 9 may confirm that the aforementioned application has run an authenticating program (the user authenticating means 10) when an application registered in the application running means 7 has been run, and if the run confirming means 9 has not been run, then may be run by the aforementioned application. This makes it possible to control the user authentication for a plurality of applications by a single user authenticating means 10, improving the operating efficiency because it is not necessary to perform the user authentication, through, for example, inputting the password, each time another application is run while any of the applications are running. Moreover, because the run confirming means 9 are not run during the execution of an application aside from a registered application, said run confirming means 9 is not run, so memory beyond that which is required is not used, and the negative effects such as a reduction in the operating speed does not occur. Note that the authenticating program according to the present example of embodiment is structured through the aforementioned authentication data inputting means 11, the user authenticating means 10, and the run confirming means 9.

Moreover, this system is structured such that an operating application that is executed by the application executing means 2 is run by an authentication program (the user authenticating means 10). Additionally, the present system is provided with authentication data maintaining means 18 for maintaining authentication data pertaining to the validity/invalidity of the authentication by the user authenticating means 10, where the operating application exchanges signals with the authentication program to determine whether or not the operation program itself is still running. Furthermore, the authentication program is structured so as to determine to terminate itself so as to prevent itself from being run too many times.

Moreover, the system described above is provided with a inspection scenario storage unit 17 which functions as a second program storage unit according to the present invention for storing multiple types of inspection scenarios for detecting changes in the system operations in each application, corresponding to the respective multiple types of applications described above. Moreover, an inspection executing means 19 is provided for detecting changes in each application through sequentially executing the inspection scenarios of the aforementioned inspection scenario storage unit 17 through inputting inspection execution signals from an input device, such as a mouse or a keyboard.

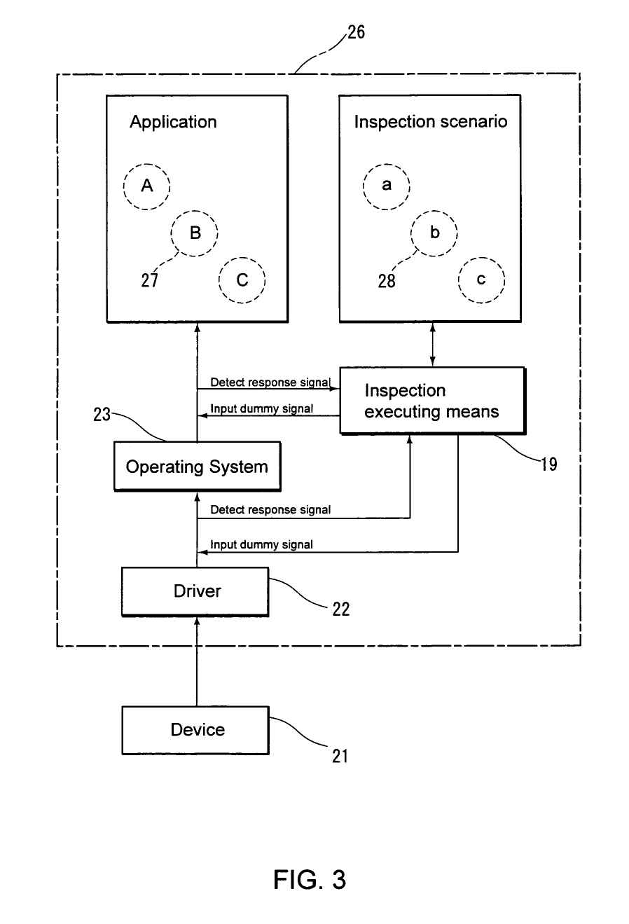

Here, as is shown in FIG. 3, multiple types of operating applications 27 and inspection scenarios 28 are prepared, with a one-to-one correspondence between operating applications 27 and inspection scenarios 28. In the example shown in the figure, inspection scenario a, inspection scenario b and inspection scenario c correspond to application A, application B, and application C, respectively.

Any of these operating applications 27 and inspection scenarios 28 can be implemented as appropriate from the aforementioned program implementing means 29. That is, when, at the start of operations, an operating application 27 is, implemented, complementarily, not only is the complementary operating application 27 implemented, but the corresponding inspection scenario is also implemented at the same time. In this way, the operating application 27 and the inspection scenario 28 are always implemented and used in one-to-one sets.

Here, the inspection scenario includes, at least, data for specifying the application program to be inspected, data for inputting as dummy signals into the application program, and data regarding the allowable range (allowable values) of responses to this data.

In this way, because there are multiple independent operating applications 27, that are functionally divided by data item and/or operation, it is possible to perform inspections by running only the inspection scenario 28 that corresponds to the application 27, without performing an inspection on the entire system, when there has been an upgrade, or the like, to a portion of the application 27, making it possible to perform inspections with certainty while vastly reducing the work in validations and inspections after the system has begun operations. Moreover, the automatic execution of the inspection scenario 28 for each of the operating applications 27 in sequence periodically makes it possible to expedite and simplify system inspections as well through automatically performing inspections on the system as a whole and automatically performing validations. Consequently, it is possible to perform automatic inspections of the system after an update such as a security patch in the operating system.

Moreover, because the inspections and validations on the system as a whole are expedited and simplified, it becomes possible to operate in a state of high security through performing inspections after, for example, performing immediate updates when security patches, or the like, are provided. As a result, it is possible to perform inspections and validations easily each time there is a system update, and when there is a change in operations accompanying an update, the changes can be detected, making it possible to guarantee rigorous GLP, or the like. Moreover, because there are multiple independent applications 27, functionally divided by data item and/or operation, those unnecessary applications 27 (those for which the likelihood of use is small) need not be implemented, and it is possible to reduce substantially the system implementation cost and operating cost as well.

Moreover, as is shown in FIG. 3, the inspection of each of the applications 27 by the aforementioned inspection executing means 19 (inspection scenario programs) are performed through the application 27 to be inspected being specified by the inspection scenario 28, the inputting of dummy signals directly into the specified application 27, the detecting of the signals that are the responses to the aforementioned inputted dummy signals, and the comparison of the detected response signals to those from prior to the inspection.

That is, normal operating signals are inputted by a device 21 for inputting, such as a mouse of a keyboard, where the physical signals that are generated by the device 21 are converted, by drivers 22, for the devices 21, into signals that have meaning, where these operating signals are inputted into each of the applications 27 through the operating system 23. In the inspection scenarios 28 according to the present invention, the dummy signals are generated in the same manner as the operating signals that are normally inputted through a device 21 and converted by the driver, and then inputted directly into the application 27, either through the operating system 23 or not through the operating system 23. Moreover, the inspection executing means 19 detects the response signals, which are the responses by the application 27 to the aforementioned inputted dummy signals, and compares these detected response signals to response signals from before the beginning of the inspection, which were stored in the inspection results storage unit 20, and if the response signals are outside of an allowed range which is listed in the inspection scenario 28, then a “Fail” signal, indicating that there has been a change, is outputted, where otherwise [any change] is ignored and the inspection is continued. Note that the “Fail” signal is displayed by displaying on a screen a display that change has been detected, where the display continues until checked by a user. The inspection executing means 19 outputs and records, in the form of a log, the aforementioned changes and the name of the user that performed the check (acquired from the user authenticating means 10).

Inputting the dummy signal directly into the application 27 in this way makes it possible to detect pure system changes, excluding changes caused by the devices 21 and the drivers 22. Consequently, even if there were changes in the devices 21 or the drivers 22, there would be no impact on the operations or inspections.

Here the inputting of the aforementioned dummy signals can be performed without passing through the operating system 23. Doing this makes it possible to detect pure system changes excluding those that are caused by not only the devices 21 and the drivers 22, but by the operating system 23, by inputting directly the dummy signals into the application 27 without passing through the operating system 23.

Moreover, the inputting of the aforementioned dummy signal can be performed through the operating system 23. Doing so makes it possible to detect changes in the system that include the operating system 23, because the dummy signals are inputted directly into the application 27 through the operating system 23. Consequently, even if there has been an update, such as when there is a security patch to the operating system 23, it is possible to detect changes in the system taking the security patch into account, making it possible to guarantee the GLP rigorously. In this way, inspection is performed with the operating system 23 being updated regularly, enabling operations in a highly secure state.

At this time, the aforementioned inspection scenarios 28 are structured so as to detect changes when a change that affects the system operations has been detected, but does not detect changes when, for example, there has been a change that does not affect the system operations.

In other words, for response signals that are responses from the application 27 to the inputted dummy signals, when there is a decision as to whether or not there has been a change (“OK” or “Fail”), a specific standard range is set for determining whether or a change in the response signal from the previous system is OK, to make the “OK decision,” where if the response signals are within the specific standard range, then the result is “OK,” but if a change is detected that exceeds the aforementioned standard range, the result is (“Fail”).

For example, even if there is some degree of change in the response signal to the inputted dummy signal, if that change is a minor change in the size of the font, or some degree of change in the background color, changes of these levels have absolutely no problem in terms of the operation of the system. When all of these types of changes are defined as “Fail,” then the frequency with which there are “Fail” outputs will increase dramatically, and it will be necessary to perform manual operation processes ultimately requiring human attention, to each of the “Fail” outputs. Given this, when compared to the conventional system, rather than outputting all changes as being “changes” with “Fail” outputs, the standard range, as described above, is established, making it possible to reduce substantially the amount of reconfirmation working requiring human attention for “Fail” outputs by not recognizing as “changes” those changes of a level that has no impact whatsoever on the operation of the safety test support system that guarantees the GLP or the like, within the aforementioned standard range, such as, for example, a minor change in font or a minor change in display color, through setting the standard range as described above.

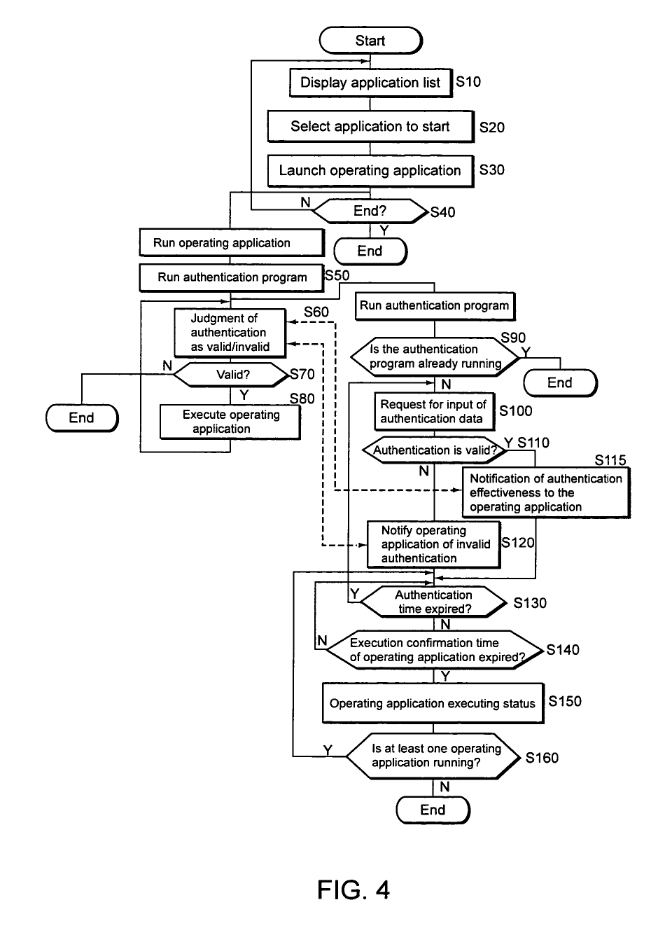

FIG. 4 is a flow chart illustrating the operation of the aforementioned system. Note that in the chart, “S” is an abbreviation for “Step.”

First, at the time of system implementation, a receiving test is started. In this receiving test, body weight, feeding, water, amount of urine, and pathological observations are inputted through data inputting means 1 (for example, the various devices 21, such as an electronic balance), where the tabulation, etc., is performed through the application executing means 2, and a check is performed to insure that accurate tabulation results have been obtained. Moreover, the inspection scenario 28 is executed by the inspection executing means 19, to confirm whether or not the applicable inspection scenario 28 operates correctly.

At this time, the inspection results storage unit 20 records the data inputs for the body weight, feed, water, etc., in the aforementioned tests that were received, and the processes such as the tabulation, etc., of the inputted data, along with the operating results. At this time, for the various operating results described above, a specific standard range should be set up in the aforementioned scenario 28. However, the present invention is not limited thereto, and the aforementioned standard range may be determined other than through the results of measurements.

The actual system operation is started after the receiving test has been completed. In normal operations the system is operated continuously without performing validations.

In normal operations, the following operations are performed.

First, the running program (the application running means 7) is run to display, on the display means 4, a list of registered programs (S10: See FIG. 2). Next, when the icon 15 of the desired program is clicked to select the desired operating program from the menu 14 displayed on the screen 16 of the display means 4 (S20), the running of the operating application commences (S30). Following this, the application that was run is executed, the body weight, amount of feed, water, urine, etc., clinical and pathological observations, and other data are inputted, the inputted data is tabulated, the tabulated data is compiled and outputted, and other processes are performed depending on the specific application. After this, if the running program has not terminated, then processing returns to Step 10, or, otherwise, the process is completed (S40).

When, in Step 30, the operating application runs, then the running of the authentication program (run confirming means 9) is started (S50). When the authentication program runs, processing advances to Step S90, a check is performed as to whether or not the authentication program is already running, and if the authentication program is already running, the authentication program run operation is aborted in order to prevent having a redundant program run, but if the authentication program is not already running, processing advances to Step 100.

In Step 100 the input of the authentication data, such as the password and user ID, is requested from the authentication data inputting means 11. In Step 110, a decision is made as to whether the password and user ID inputted in Step 100 are valid or invalid. If, in Step 110, the authentication is valid, then a valid authentication notice is sent to the operating application, and the valid authentication data is maintained in the authentication data maintaining means 18 (Step 115). If, on the other hand, the correct password is not inputted in Step S110 so that the authentication is invalid, then an invalid authentication notification is sent to the operating program, and invalid authentication data is maintained in the authentication data maintaining means 18 (S120).

Here, in Step 110, if the correct authentication data was not inputted, due to an incorrect password being inputted, or the like, the input of the authentication data is requested again, and if the user could not be authenticated through the inputting of a valid password in a specific number of repeated tries, then a forced termination instruction may be issued to the application, which is in a temporarily disabled state, and the application, having received the termination instruction, may be terminated.

Following this, the elapsing of the authentication time over which the user is authenticated (for example, 30 minutes, although it is preferable for the user to be able to set the range of time freely) is awaited (S130). Once the aforementioned authentication time has elapsed in Step 130, then processing returns to Step 100, and the input of authentication data is requested again. If the aforementioned authentication time has not elapsed in Step 130, then a decision is made as to whether or not an execution confirmation time for the operating application has elapsed (S140). In Step 140, if the aforementioned execution confirmation time has not elapsed, then processing returns to Step 130, and the aforementioned operations of waiting for a repeat authentication time to elapse is repeated. In Step 140 a check is performed as to whether or not the operating application is running if the aforementioned execution confirmation time has elapsed (S150). If in Step 160, even a single operating application is running, then again the elapsing of the authentication time is awaited, and the operations described above are repeated. In Step 160, if not even a single application program is running, then the authentication program terminates.

On the other hand, the running of the application is started in Step 30, and after the authentication program running is started in Step 50, after which processing advances to Step 60, and the information regarding whether the authentication is valid or invalid, maintained in the authentication data maintaining means 18, is checked through an exchange of signals with the aforementioned authentication program.

In Step 70, if the authentication maintained in the authentication data maintaining means 18 is valid, processing advances to Step 80, and the operating application is executed, while if the authentication maintained in the authentication data maintaining means 18 is invalid, then the procedure to run the operating program is aborted. Note that when the authentication is valid, the user name pertaining to the authentication for the aforementioned application is recorded, and is associated with the application and the currently logged-in user. Note that this relationship is not limited to the direct relationship between the application and the user name, but may be made through a method such as recording the application run and termination time or the user's login/logout time and matching afterwards.

In this way, the system as described above makes it possible to guarantee strict GLP, or the like, through making it possible to establish the person that performed the checks of the test results because the user is authenticated at prescribed intervals over which any of the executed applications are running. Moreover, because there are multiple independent programs that are functionally divided based on data items and/or operations, when one program is upgraded, validations will only be necessary on that particular program. Consequently, it is possible to guarantee GLP, and the like, through strictly performing the validations after the system is in use. Additionally, because there is no need to implement unnecessary programs that are unlikely to be used, it is possible to reduce the cost of the system as a whole substantially.

Moreover, once the authentication program has authenticated a user, then user authentication is not performed each time an additional operating program is running, thus minimizing redundant work and improving ease of use.

Moreover, because it is possible to control the authentication of multiple applications using a single user authenticating means, as long as any of the programs is operating it is not necessary to perform user authentication each time another application is running, and thus operating efficiency is increased. Moreover, because the user authenticating means does not run during the execution of an application aside from a registered application, unnecessary memory is not consumed, thus problems such as reductions in processing speed do not occur.

The system described above is suitable for use in pharmaceutical toxicity studies using animals as the organisms. This is because these toxicity studies involve a large amount of many different types of data, and the types of data usually vary depending on the user, but with this system it is possible to greatly reduce the overall system cost by implementing only the necessary programs that have a high probability of being used. This is because data entry and the like is often done among multiple observers over time, so the effectiveness of the present invention of being able to confirm the person entering the data at regular time intervals is obvious, and successful.

FIG. 8 is a flow chart of automatic inspection in the system described above.

This process has the following validation steps:

Design Qualification (DQ): When there are changes in required specifications, functional specifications, performance specifications, manufacturer selection criteria prior to purchasing equipment, or changes in the purpose for use.

Installation Qualification (IQ): Comparison with purchase orders, confirmations of installed hardware/software, after system upgrades/system migration.

Operational Qualification (OQ): Prior to use of important functional routines and at least once per year.

Performance Qualification (PQ): Performance for each purpose of use, preventive maintenance, prior to operational performance checks at the time of use, during use, daily or during use.

That is, the validations are not only the Installation Qualification (IQ), but rather validations of Operational Qualification and Performance Qualification (OQ and PQ) during use are also important. For example, if the system is linked to spread sheet software, qualification confirmations must be performed when there is a version upgrade of the spread sheet software. In some cases, it is necessary to perform confirmations after updating the web browser as well, even if not explicitly linked. When there is a change in this way, it is impossible to respond using a method that performs validation if the change is made without the knowledge of the user. Given this, with the TOX Launcher the validations can be performed automatically at regular intervals. Specifically, the validation procedures are recorded or programmed, and functions are added all the way to results determination.

First a mouse of keyboard is used to input the inspection execution signal (or a periodic automatic run command is given from the aforementioned run program) to cause each of the inspection scenarios 28 to be read out from the inspection scenario storage unit 17 (S1). Then, of the multiple inspection scenarios that have been read out, the single inspection scenario a (See FIG. 3) is started (S2). Next, in the inspection scenario that has been run, dummy signals are inputted into the application A that is the target of inspection by the inspection scenario a, and the response signals for the dummy signals from the aforementioned application A are detected (S3).

Next, the detected test signals are compared to the inspection results stored in the inspection results storage unit 20 to determine whether or not there has been a change during the operation of the system. At this time, the aforementioned response signal is judged as to whether or not it is within the standard range that was established at the time of the initial Installation Qualification (S4) and if within the standard range, then the change is viewed as a change that has no impact on the system operation, so the change is ignored, and processing advances to performing the test in Step 6. On the other hand, if the aforementioned response signal is outside of the aforementioned standard range, then a “Fail” is outputted as the change being a change that has an effect on the operation of the system (S5), after which inspection is performed by advancing to Step 6. The aforementioned “Fail” output is displayed on, for example, the display means 4, such as a display, and the applicable application name, applicable location, details of the change, and so forth, are specified, where the details of the user checks pertaining thereto are outputted to outputting means 3, such as a printer, or are recorded as a log.

Note that when there has been a display based on the “Fail” output, then when a specific amount of time has elapsed, the aforementioned authenticating means 10 may request the user to perform the authentication procedure again. At this time, a different user may log in as well, in which case, the different user name will be recorded in association with the aforementioned “Fail” and the user authentications thereof. This makes it possible to record accurately the facts regarding who performed the check. Consequently, when one wishes to strictly control the users, then it is preferable to reduce the time interval between authentication checks using the aforementioned authenticating means 10.

Moreover, when one unit program has been terminated (S7), then not only are the current validation results and comparative results outputted to the outputting means 3, but also the inspection results are stored and exist in the inspection results storage unit 20, where, additionally, a decision is made as to whether or not all of the unit programs (a, b, or c in the example in FIG. 3) have been terminated (S8), and if not all have been terminated, the processing returns to Step 2, the execution of the next unit program b is started, but if all have been terminated, then the automatic inspection is complete.

In this way, the safety test support system as described above, automatically performs the validations for the second time and beyond, making it possible to complete in a single evening what used to require three or more months for a staff of two to three individuals. Consequently, not only are validations performed regularly while the system is in operation, but also validations can be performed frequently, even when the operating system or other unrelated software is updated, making it possible to insure strict compliance with GLP, and the like. Moreover, because it is possible to perform validations independently, it becomes possible to use general-use equipment, which can vastly decrease the cost of system implementation.

Moreover, because the procedures for the validations that are, of necessity, performed at the time of the Installation Qualification are stored in order to perform the validations for the second time and beyond, it is possible to perform the necessary validations for the second time and beyond automatically at each recipient site, even for customized systems.

This type of safety testing support system is well suited for use in pharmaceutical toxicity testing that uses animals as the organisms. This is because pharmaceutical toxicity testing that uses animals as the organisms requires a large number of various different types of data processing, and because of the need to have low system implementation costs, making the ability to use generalized equipment extremely effective.

Note that the system according to the present invention is not limited to only pharmaceutical toxicity testing using animals as organisms, but rather can be applied also to pharmacological tests prior to safety testing using animals, general pharmacological testing, pharmacokinetic testing, clinical tests to which GCP (“Good Clinical Practice”—the standards pertaining to the execution of clinical pharmacological studies), and the like, as well. Moreover, the system according to the present invention can be applied also to non-GLP tests. The same effects are produced even in these cases.

Note that in the present invention, “chemical product” is not limited to a pharmaceutical product, but rather the intent thereof includes a variety of chemical substances, including agricultural chemicals, food additives, preparations for external use in treatment of the skin, and so forth.

Moreover, in the various forms of embodiments described above, the operations such as the program running operations (steps 10 through 40), the program run confirmation operations (steps 90 through 160), and the operating program run operations (steps 50 through 80) were explained as a series of routines; however, the intent thereof also includes cases wherein execution is non-simultaneous, wherein each is executed individually.

Moreover, while in the various forms of embodiments described above, the inputting of the authenticating data was performed by inputting a password using a keyboard, the present invention is not limited thereto, but rather can be performed using an ID card such as an electromagnetic card or an IC card, or a fingerprint, voiceprint, or iris identification device, or the like. For example, through including a fingerprint authentication means in the mouse, the above-mentioned periodic authentications can be carried out, without needing to frequently display an authentication screen to the user.

We claim:

1. A computer software program article comprising a storage medium having stored thereon a computer software program which when executed causes a detection of whether or not there have been one or more specific changes in one or more application programs running on a computer system, said computer software program comprising:
an authentication program for authenticating a user prior to the execution of at least one of said application programs, and for associating the user in the aforementioned authentication to an application program that will be run later;
inspection scenarios, associated with each of said application programs and stored on said storage medium, for detecting whether or not there have been specific changes in each of said application programs; and
an inspection scenario program for detecting whether or not there has been a specific change in an application program, by running said associated specific application program according to said associated inspection scenario, and for outputting detection results in association with said user name and said application program.

2. A computer software program article as set forth in claim 1, wherein:
said one or more application programs includes an application program executor for displaying the other application programs to the user selectively and executably.

3. A computer software program article as set forth in claim 1, wherein:
said one or more application programs is a plurality of application programs requiring validations in order to fulfill specific standards under identical policies;
said inspection scenarios are for detecting whether or not changes in each application program are to the degree that allows execution of the application program without performing a re-validation; and
said inspection scenario program instructs said computer system to display the detection result, when, in accordance with said inspection scenario, a change of an extent greater than that wherein execution is allowed without performing validations in detected.

4. A computer software program article as set forth in claim 1, wherein:
said inspection scenario program inputs a dummy signal into said application program in accordance with said inspection scenario to detect a response signal to said inputted dummy signal, to thereby detect whether or not there has been a specific change in the application program.

5. A computer software program article as set forth in claim 4, wherein:
said inspection scenario includes at least data for specifying an application program to be subjected to inspection, data for inputting as dummy signals into said application program, and data regarding an allowable range regarding the response to said data.

6. A computer software program article as set forth in claim 1, wherein:
said inspection scenario program is launched as specific time intervals.

7. A computer software program article as set forth in claim 1, wherein:
said inspection scenario program comprises a detection results display step for displaying said detection results on a computer display, and a user input/output step for receiving user input regarding said detection results and for outputting in association with said detection results.

8. A computer software program article as set forth in claim 1, wherein said authentication program:
comprises an authentication update requesting article for requesting the input of user authentication data at each specific time interval; and
if the user cannot be authenticated by said authentication update requesting article, terminates said application program that is running, associated with the applicable user.

9. A computer software program article as set forth in claim 1, wherein:
said authentication program performs repeat user authentication in response to a user request after an initial user authentication, and associates, with the user involved in said authentication, the application programs currently running, and application programs run thereafter.

10. A computer software program article as set forth in claim 1, wherein said computer software program is for insuring that the results of safety testing have not been falsified or tampered with in said application program; and
wherein said application program receives measurement values, which have not been falsified or tampered with, from a measurement device for safety testing, processes the measurement values, and outputs the results of specific processing.

11. An application program inspecting system comprising:
an application storage unit for storing one or more mutually-related application programs;
an authentication unit for performing user authentication prior to running at least the first of said application programs, and for associating application programs run thereafter, with the user involved in said authentication;
an inspection scenario storage unit for storing inspection scenarios, associated with each of said application programs, for detecting whether or not there have been specific changes in each of said application programs; and
an inspecting unit for detecting whether or not there have been specific changes in said application programs, through an inspection scenario program executing specific related application programs in accordance with said associated inspection scenarios, and for outputting said detection results in association with said user name and application program.

12. A method implemented using a computer for detecting whether or not there have been one or more specific changes in one or more mutually-related application programs on a computer system, comprising:
an authentication process for performing user authentication prior to running at least the first of said application programs and for associating, with said application programs run thereafter, the user involved in said authentication;
and an inspection process for detecting whether or not there has been a specific change in said application program, through the use of an inspection scenario, associated with each application program, for detecting whether or not there has been a specific change in each of the application programs, by an inspection scenario program executing a specific related application program in accordance with said associated inspection scenario, and outputting the detection results in association with said user name and application program.
